(19) United States
(12) Patent Application Publication
(10) Pub. No.: US 2018/0144419 A1
(43) Pub. Date: May 24, 2018

(54) SYSTEMS AND METHODS FOR COMPILING UTILITY ASSET INFORMATION

(71) Applicant: 1020 Digital, LLC d/b/a CNX, Louisville, KY (US)

(72) Inventors: Brian Russell Mefford, Alvaton, KY (US); Michael Alexander William Shafer, III, Lampe, MO (US); Matthew Todd Steadman, Las Vegas, NV (US)

(21) Appl. No.: 15/820,828

(22) Filed: Nov. 22, 2017

Related U.S. Application Data
(60) Provisional application No. 62/425,742, filed on Nov. 23, 2016.

(51) Int. Cl. G06Q 50/06; G06Q 30/06; G06Q 30/02

(52) U.S. Cl. CPC G06Q 50/06; G06Q 30/0283; G06Q 30/0645

(57) ABSTRACT

Embodiments provided herein include systems and methods for compiling utility asset information. As such, one embodiment includes receiving utility asset information regarding a utility asset, where the utility asset information includes a location of the utility asset, owner data regarding an owner of the utility asset, and a characteristic. Some embodiments include calculating a value of the utility asset based on the location and the characteristic and receiving a request by a user to acquire access to the utility asset for providing a utility service, where the request indicates that the user desires to acquire access via at least one of the following: lease or purchase. Some embodiments include providing information related to the request to the owner of the utility asset and conducting a transaction to provide access to the utility asset to the user.

### CROSS REFERENCE

This application claims the benefit of U.S. Provisional Application No. 62/425,742, filed Nov. 23, 2016, which is hereby incorporated by reference in its entirety.

### TECHNICAL FIELD

Embodiments described herein generally relate to systems and methods for compiling utility asset information and, more specifically, to embodiments for providing an interactive portal that provides municipalities, carriers, and others the ability to determine the current utility and related infrastructure within a locale and to facilitate the lease of such utility assets.

### BACKGROUND

As the utility industry, such as telecom, continues to evolve and develop, more providers are turning to underutilized or unused municipality-owned utility assets to expand these service offerings. As an example, utilities were historically limited to electricity, water, gas, and landline telephone. However, today, demand exists not only for these services, but for additional services, such as cable internet, wireless internet, cellular coverage, and fiber optic networks. These services are demanded by consumers and businesses located within a municipality, as well as by consumers and businesses looking to relocate to that municipality. Many municipalities own existing infrastructure that is either underutilized or not currently used which, if leased to utility providers and others to satisfy their growing demands, may improve coverages and expand service offerings to consumers while also generating revenues for the municipalities. As a result, municipalities need a platform to inventory and track existing utility assets and infrastructure, and to manage and facilitate the provider requests to utilize such utility assets. Municipalities, providers and others need a mechanism to determine and identify the current utility and related infrastructure within a locale, as well as a mechanism to allow providers and others to readily locate and identify utility assets of interest.

Utility providers recognize that consumers and the municipalities in which they live and work are increasingly sophisticated and demand more and improved utility services. Thus utility providers need to be able to nimbly identify a demand, a service deficiency, as well as options to improve or expand its service offerings within municipalities. Once the demands and deficiencies are identified, and municipality-owned utility and related infrastructure utility assets which will meet the demands of the providers are located, both municipalities and service providers may easily communicate and negotiate the lease of such utility assets—improving service offerings to consumers and businesses and generating revenues for the municipality via a quicker and less complicated expansion of the provider's services.

### SUMMARY

Embodiments provided herein include systems and methods for compiling utility asset information. As such, one embodiment includes receiving utility asset information regarding a utility asset, where the utility asset information includes a location of the utility asset, owner data regarding an owner of the utility asset, and a characteristic. Some embodiments include calculating a value of the utility asset based on the location and the characteristic and receiving a request by a user to acquire access to the utility asset for providing a utility service, where the request indicates that the user desires to acquire access via lease and/or purchase. Some embodiments include providing information related to the request to the owner of the utility asset and conducting a transaction to provide access to the utility asset to the user.

One embodiment of a system includes a computing device that includes a processor and memory. The memory may store logic that, when executed by the processor, causes the system to receive utility asset information regarding a plurality of utility assets, where the utility asset information includes a location of at least a portion of the plurality of utility assets, owner data regarding an owner of at least a portion of the plurality of utility assets, and a characteristic of at least a portion of the plurality of utility assets. In some embodiments, the logic causes the system to calculate a value of at least one of the plurality of utility assets based on the location and the characteristic, receive a request by a user to acquire access to the utility asset for providing a utility service, provide information related to the request to the owner of the utility asset, and conduct a transaction to provide access to the utility asset to the user.

One embodiment of a non-transitory computer-readable medium includes logic that, when executed by a computing device, causes the computing device to receive utility asset information regarding a plurality of utility assets, where the utility asset information includes a location of at least a portion of the plurality of utility assets, owner data regarding an owner of at least a portion of the plurality of utility assets, and a characteristic of at least a portion of the plurality of utility assets. In some embodiments, the logic causes the computing device to calculate a value of at least one of the plurality of utility assets based on the location and the characteristic, where calculating the value of the utility asset includes weighting a plurality of characteristics of the utility asset based on a predetermined algorithm, where the predetermined algorithm is determined based on a characterization of the utility asset into an asset type. In some embodiments, the logic causes the computing device to receive a request by a user to acquire access to the utility asset for providing a utility service, provide information related to the request to the owner of the utility asset, and conduct a transaction to provide access to the utility asset to the user.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a computing environment for compiling utility asset information, according to embodiments described herein;

FIG. 2 depicts a user interface for providing compiled utility asset information, according to embodiments described herein;

FIG. 3 depicts a user interface for providing options related to utility infrastructure, according to embodiments described herein;

FIGS. 4A-4G depict a list of utility assets for a given location, broadband, tower and other data and information, as well as information for each customer, according to embodiments described herein;

FIG. 5 depicts a user interface that further identifies user-selected utility assets for a given location, according to embodiments described herein;

FIG. 6 depicts a user interface that identifies user-selected utility assets for a predetermined customer, according to embodiments described herein;

FIG. 7 depicts a user interface that provides characteristics of a predetermined utility asset, according to embodiments described herein;

FIG. 8 depicts a user interface that provides imagery for a predetermined utility asset, according to embodiments described herein;

FIG. 9 depicts a user interface that provides a search ring for searching predetermined utility assets within a user-defined radius, according to embodiments described herein;

FIG. 10 depicts a user interface that provides predetermined utility assets within a user-defined search ring, according to embodiments described herein;

FIG. 11 depicts a user interface that provides characteristics of a selected utility asset within a search ring, according to embodiments described herein;

FIGS. 12A, 12B depict additional characteristics of a selected utility asset, according to embodiments described herein;

FIG. 13 depicts a user interface that provides imagery associated with a selected utility asset within a search ring, according to embodiments described herein;

FIG. 14 depicts a user interface that provides a measurement associated with a user defined area, according to embodiments described herein;

FIG. 15 depicts a user interface that provides utility asset leasing information for a selected utility asset, according to embodiments described herein;

FIG. 16 depicts a user interface that provides an option for a user to request additional information associated with a selected utility asset, according to embodiments described herein;

FIG. 17 depicts a user interface for providing a user with a list of pending requests, according to embodiments described herein;

FIG. 18 depicts a flowchart for providing complied utility asset information, according to embodiments described herein;

FIG. 19 depicts a flowchart for assessing coverage limitations for a utility asset owner, according to embodiments described herein; and

FIG. 20 depicts a computing device for providing compiled utility asset information, according to embodiments described herein.

### DETAILED DESCRIPTION

Embodiments disclosed herein include systems and methods for compiling utility asset information. Some embodiments may be configured to provide providers, customers, city or government leaders, engineers and others with the ability to obtain much of the information they need to make credible decisions as to infrastructure installations and other utility asset-related decisions. This information may be provided through the display of vertical and horizontal utility assets, as well as existing key pieces of data such as FCC towers, existing commercially available fiber, and the underlying data each city provides, such as electric pole information, traffic lights, building rooftop locations and heights. Additionally, embodiments may be configured to import and provide diverse data sources, such as Excel, text, KMZ, KML, Shapefiles, fiber locator data, FCC database integration, and the like.

Embodiments may also provide and/or integrate with street view software to perform virtual site walks of many facilities performing fairly accurate visual inspections of electric poles, street lights, traffic standards, water tanks, existing towers, and even estimating rooftop heights. Additionally, embodiments provide the ability to house customer sites, provide search rings, provide desired fiber routes, and essentially build plans, allowing the asset manager to work to evaluate optimal future municipal-owned-and-leased fiber routes and utility assets.

Embodiments provided herein may also be configured to use proximity analysis and logic functions to estimate the value of a newly introduced utility asset and perform other functions. Using electric grid capacity and loading data, overlaid with flood information, ground elevation, available excess fiber capacity, and/or other data, these embodiments may show where those factors overlay with one another.

Embodiments described herein may additionally take pole data, such as from a 3D camera and/or entered manually, and return a compliance rating as well as small cell viability rating (e.g., “highly likely,” “likely,” and “not very likely”) for a new installation. Some embodiments may provide a right of way audit/compliance/viability assessment and utility asset inventory as a service.

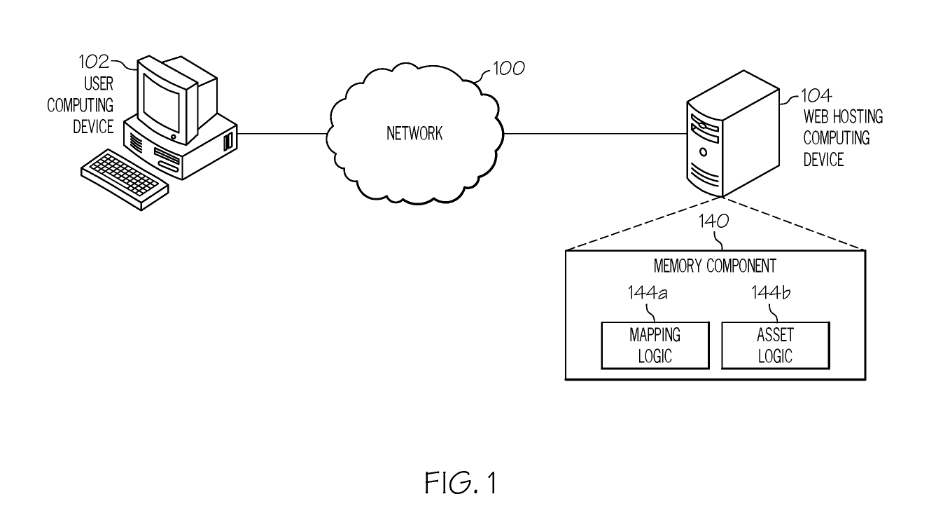

Referring now to the drawings, FIG. 1 depicts a computing environment for compiling utility asset information, according to embodiments described herein. As illustrated, FIG. 1 depicts a network 100 may include any wide area network, local network, micro-network, and/or the like. As an example, the network 100 may include the internet, a public switched telephone network, a cellular network, mobile data network, a local area network, a wireless fidelity network, a Bluetooth network and/or may otherwise facilitate communication between devices via wired and/or wireless connection and with or without an intermediary device. As an example, the network 100 may be configured to facilitate communication between a user computing device 102 and a remote computing device 104. The user computing device 102 may include any device that is configured for interfacing with a user and communicating with the remote computing device 104 as described herein. The user computing device 102 may include a personal computer, a laptop, a tablet, a mobile device, a server device etc.

The remote computing device 104 may also be coupled to the network 100 and include a memory component 140, which stores mapping logic 144a and asset logic 144b. Depending on the particular embodiment, the remote computing device 104 may or may not be configured to interface with a user (such as an administrator) and thus may be configured as a server device, a personal computer, a laptop, a mobile device, a template, etc. The mapping logic 144a may be configured to determine the location of one or more utility assets, as well as roadways and other map features. The mapping logic 144a may also be configured for providing the mapping data to a user. The asset logic 144b may be configured for determining a location of one or more utility assets, as well as characteristics of the one or more utility asset. Embodiments of the asset logic 144b may also be configured to provide a marketplace for utility asset leasing and/or provide other functionality provided herein.

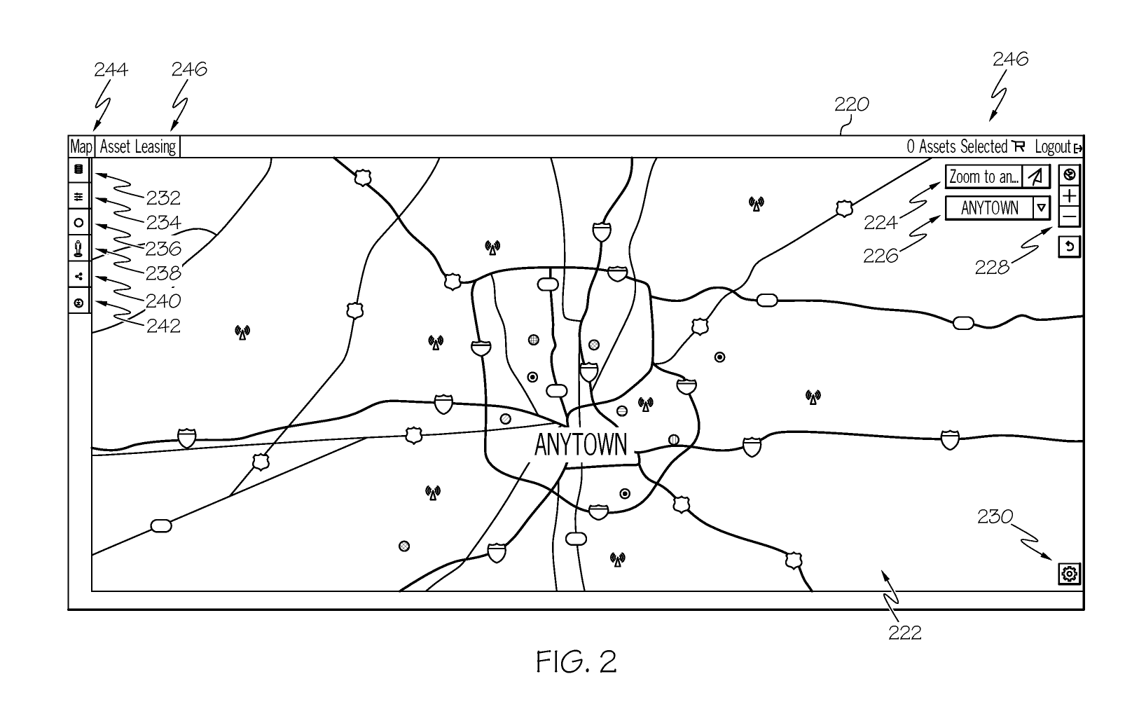

FIG. 2 depicts a user interface 220 for providing compiled utility asset information, according to embodiments described herein. As illustrated, the user interface 220 provides a plurality of options for viewing utility asset data for a geographical area. As illustrated, the user interface 220 may provide a mapping 222 of a predetermined area, such as a city. Also provided are a search function 224, a dropdown area selector 226, as well as a zoom function 228 for providing different views of the map. Also provided is a settings option 230 for setting display features, zoom features, etc.

The user interface 220 also provides an asset option 232, a search option 234, a ring option 236, a street view option 238, a measurement option 240, and an information option 242, which are each described in more detail below. Also provided are a map option 244 and an asset leasing option 246.

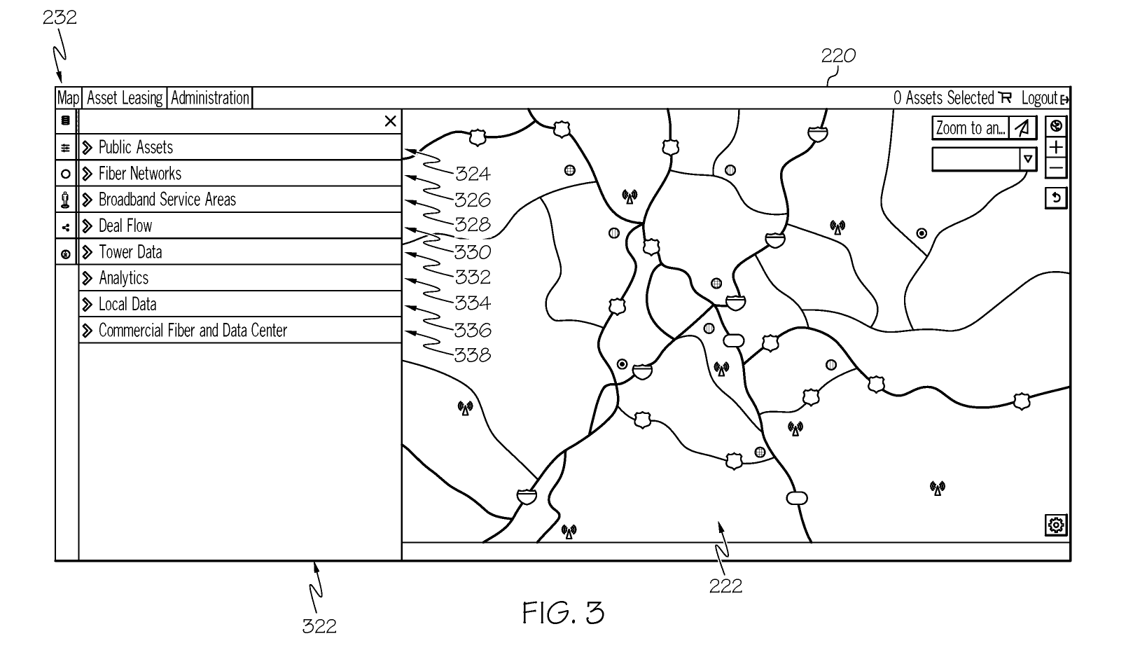

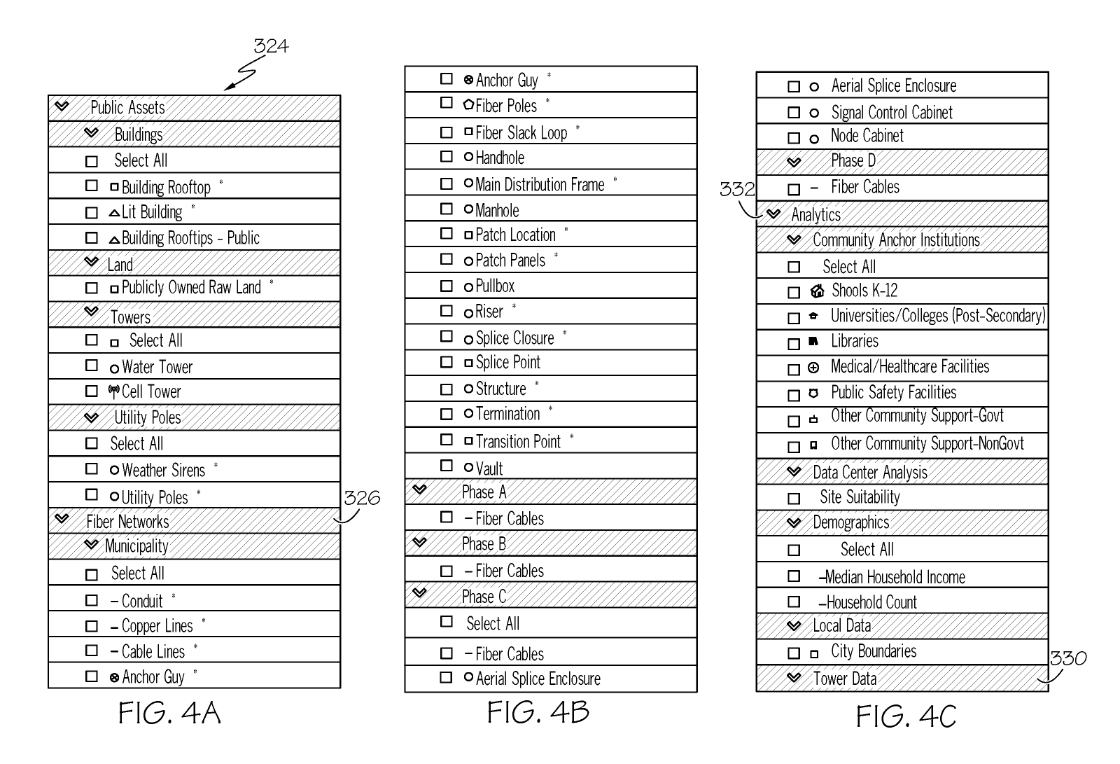

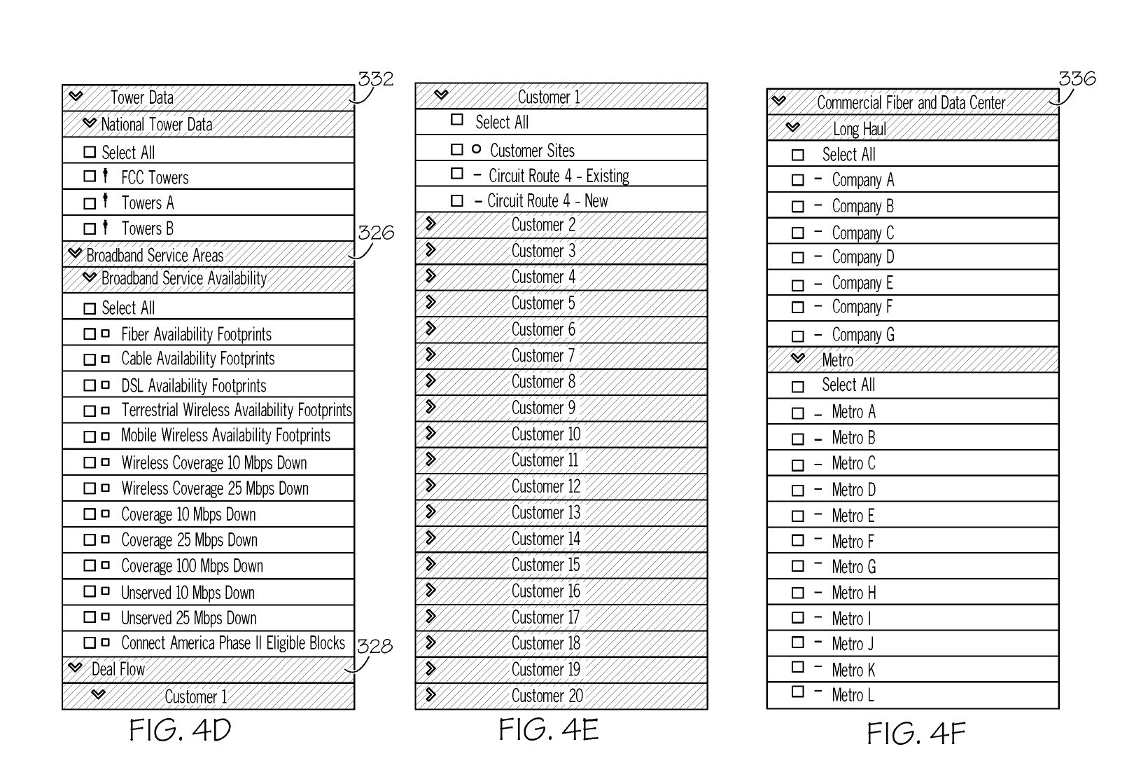

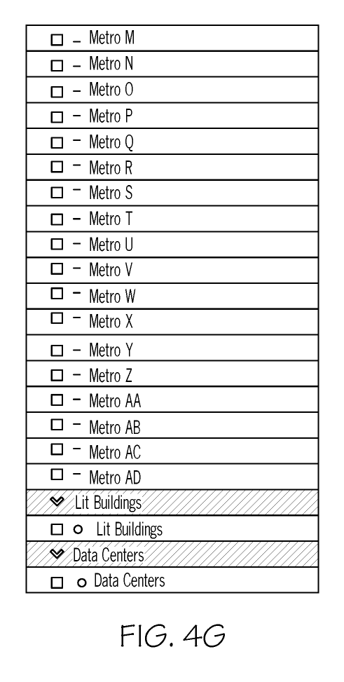

FIG. 3 depicts a user interface 320 for providing options related to utility and related infrastructure, according to embodiments described herein. In response to selection of the asset option 232 from FIG. 2, the user interface 320 may be provided, which includes a sidebar option for providing additional options related to specific utility assets. As illustrated, the asset option 232 may be configured for providing a plurality of sub-options, such as a public assets sub-option 324, a fiber networks sub-option 326, a broadband service areas sub-option 328, a deal flow sub-option 330, a tower data sub-option 332, an analytics sub-option 334, a local data sub-option 336, and a commercial fiber and data center sub-option 338. As described in more detail below, each of the sub-options 324-338 may be configured for inserting and/or overlaying an indicator onto the mapping 222 to show where the selected utility asset is located. Examples of the utility assets may be provided in FIGS. 4A-4G.

FIGS. 4A-4G depict a list of utility assets for a given location, according to embodiments described herein. As illustrated in FIG. 4A, the public assets sub-option 324 may include buildings, land, towers, utility poles, fiber networks, and the like may be provided. As illustrated, in response to selection of the public assets sub-option 324 from FIG. 3, options for selecting a building, land, towers, utility poles, etc. may be provided. Under the buildings tab, the user may select a building rooftop, a lit building, ad a public building rooftop for displaying on the mapping 222. Similarly, under the land tab, the user may select publicly owned raw land. Under the utility poles tab, the user may select weather sirens and/or utility poles.

Under the fiber networks sub-option 326, the user may select one of the municipality networks, such as conduit, copper lines, fiber cables, anchor guy (FIG. 4A), as well as fiber poles, fiber slack loop, handhole, main distribution frame, manhole, patch location, patch panels, pullbox, riser, splice closure, splice point, structure, termination, transition point, and vault (FIG. 4B). Also provided in FIG. 4B under the fiber networks tab are phase A with fiber cables, phase B with fiber cables, and phase C with fiber cables, aerial splice enclosure. FIG. 4C continues the phase C tab with options for selecting signal control cabinet and node cabinet.

FIG. 4C also provides a phase D tab with fiber cables for selection. FIG. 4C also provides the analytics sub-option 334, which may include community anchor institutions, such as schools, universities, libraries, medical facilities, public safety facilities, other community supported government institutions, and other community supported non-government institutions. The analytics sub-option 334 may also include data center analysis, such as site suitability, demographics, such as median household income and household count, local data, such as city boundaries, and the tower data sub-option 332.

FIG. 4D provides the tower data sub-option 332, which includes national tower data, such as FCC towers, towers A, and towers B. the broadband service areas sub-option 328 includes broadband service availability, such as fiber availability footprints, cable availability footprints, DSL availability footprints, terrestrial wireless availability footprints, mobile wireless availability footprints, wireless coverage down to 10 MBPS down, wireless coverage 25 Mbps down, coverage 10 Mbps down, coverage 25 Mbps down, coverage 100 mbps down, unserved 10 Mbps down, underserved 25 Mbps down, and connect America phase II eligible blocks. Also provided is the deal flow sub-option 330.

FIG. 4E provides the deal flow sub-option 330, which includes a plurality of customers, each of which may include options for customer sites, existing circuit routes and new circuit routes. FIG. 4F illustrates the commercial fiber and data center sub-option 338, which includes long haul, listing a plurality of companies, and metro, listing a plurality of metro organizations. FIG. 4G provides additional metro organizations, as well as lit buildings and data centers.

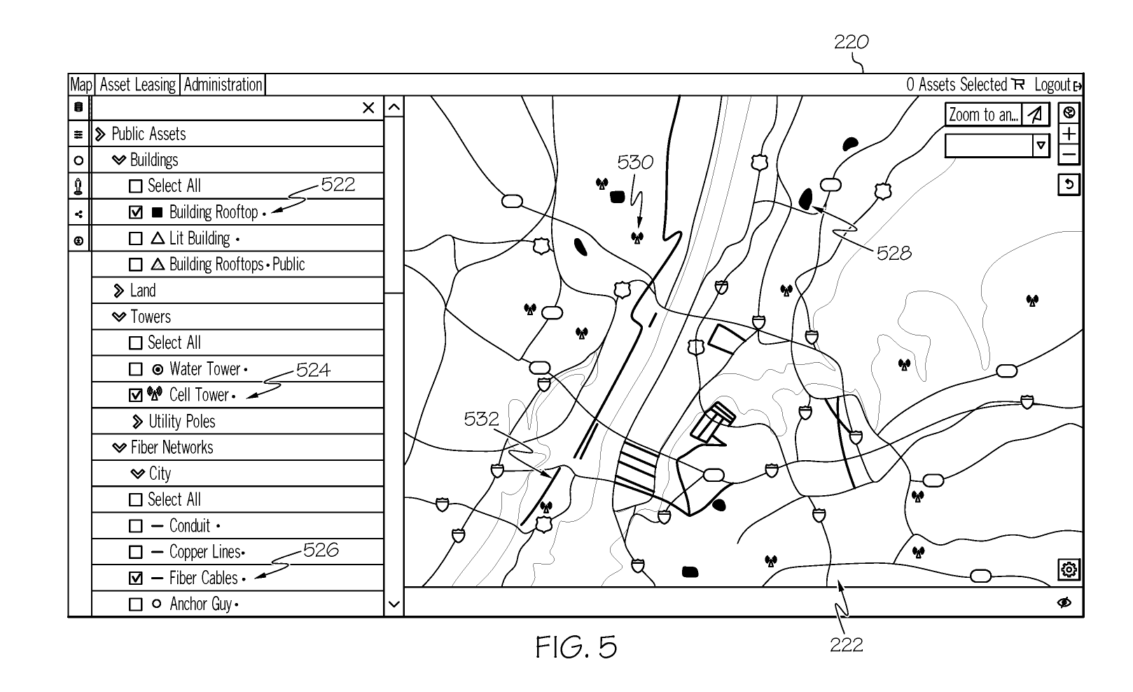

FIG. 5 depicts a user interface 520 that further identifies user-selected assets for a given location, according to embodiments described herein. As illustrated, a plurality of utility assets is selected for display in the mapping 222. As illustrated, the user has selected building rooftop option 522, which results in an overlay 528 being provided in the mapping 222. In response to selection of the cell tower option 524, the overlay 530 may be provided. In response to selection of the fiber cables option 526, the fiber cable may be highlighted and/or overlaid on the mapping 222.

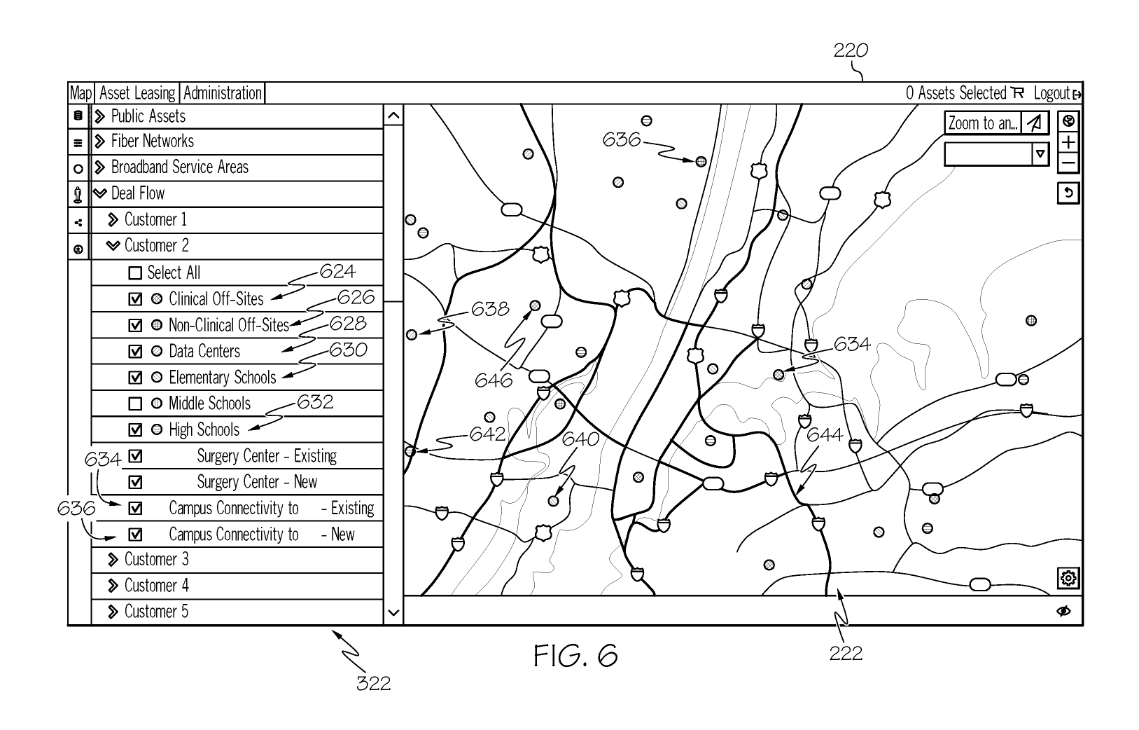

FIG. 6 depicts a user interface 620 that identifies user-selected utility assets for a predetermined customer, according to embodiments described herein. As illustrated, utility assets associated with a particular customer are selected and depicted geographically in the mapping 222. As an example, the user may select clinical off-sites option 624, non-clinical off-sites option 626, data centers 628, elementary schools option 630, high schools option 632, existing campus connectivity option 634, and new campus connectivity option 636. In response, the mapping 222 may provide indicators 634, 636, 638, 640, 642, 644, and 648, which represent the selected utility assets for the particular customer. This may be helpful to determine a customer's current footprint, as well as opportunities for expansion of one or more services.

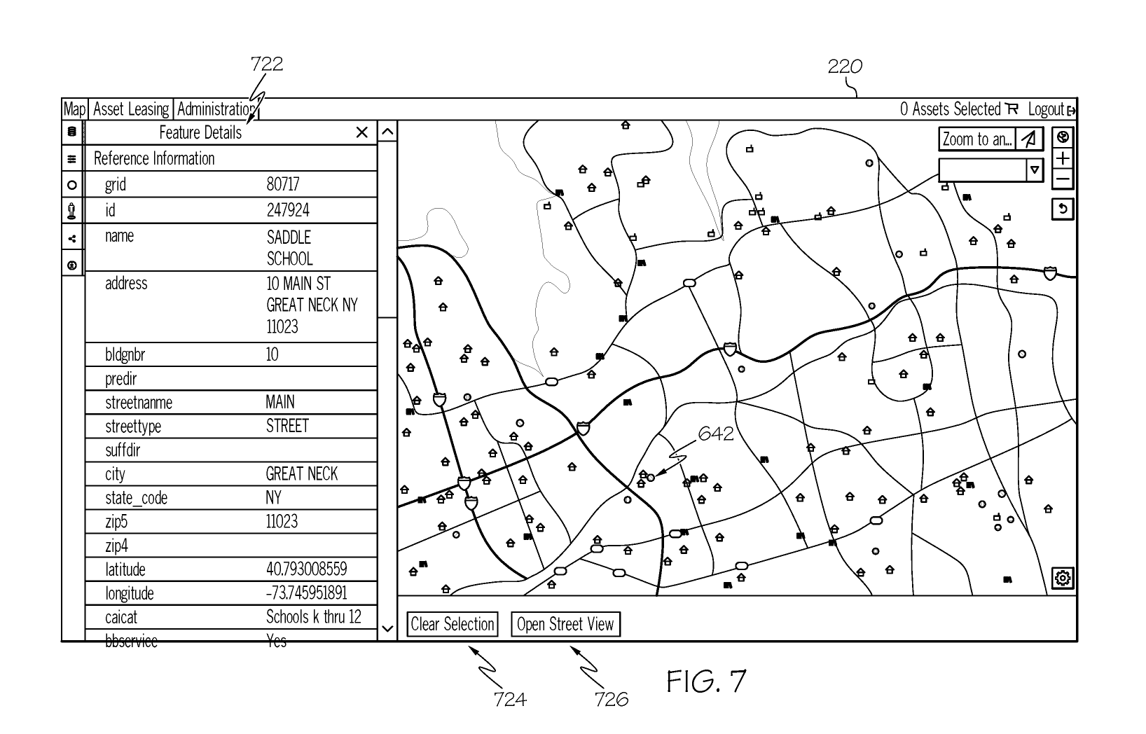

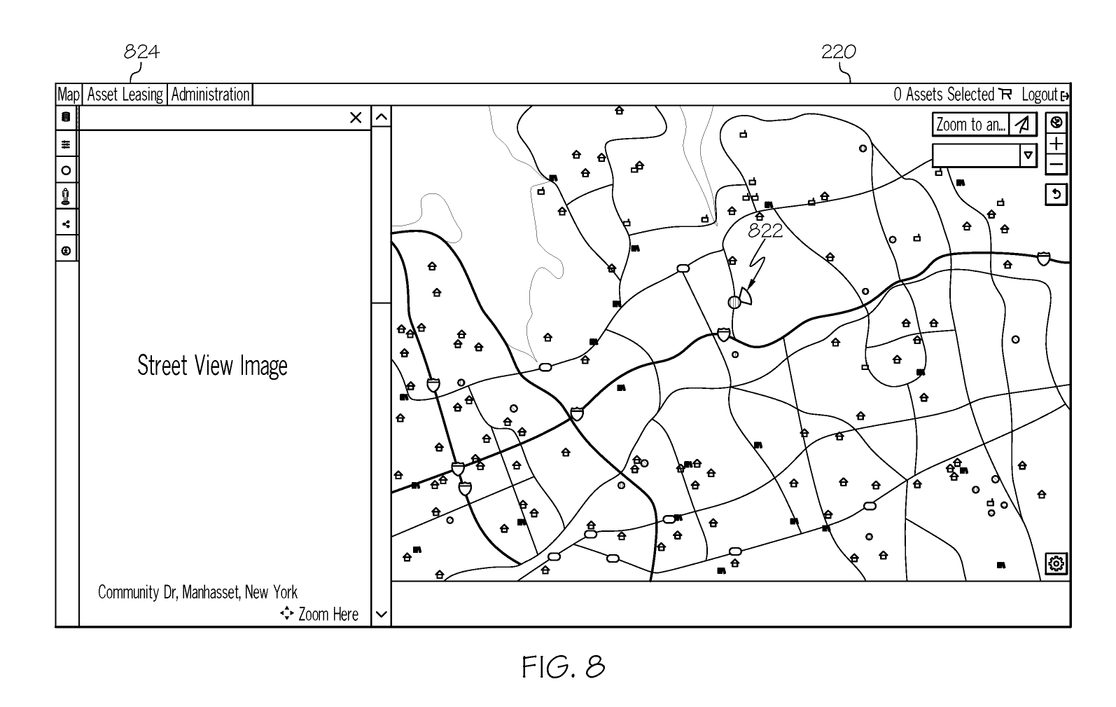

FIG. 7 depicts a user interface 720 that provides characteristics of a predetermined utility asset, according to embodiments described herein. As illustrated, a point of interest 642 may be selected by a user. In response to an additional selection of the information option 242 from FIG. 2, additional details may be provided regarding the selected asset. Provided information may include identifiers, names, address, ad/or other information regarding the utility asset.

FIG. 8 depicts a user interface 820 that provides imagery for a predetermined utility asset, according to embodiments described herein. As illustrated, in response to selection of the street view option 238 from FIG. 2, a street view of a selected asset 822 may be provided for a user to perform a virtual inspection of an existing area and/or utility asset. Additional options may also be provided, such that if information regarding the utility asset does not match the virtual depiction of the utility asset, the user may report the inconsistency for an administrator to correct.

As an example, some embodiments include providing the street view of the utility asset to the user, providing an option to adjust the characteristic of the utility asset based on an image represented in the street view, receiving a user selection of the option and a new value for the characteristic; associating the new value with the utility asset; and recalculating the value of the utility asset based on the new value. In such an example, if the users views the image from the street view and notices something that contradicts other information regarding the utility asset, the user may submit data related to the contradiction. If this information is corroborated, the value of the utility asset may be changed.

Also provided in FIG. 8 is an asset leasing option 824. In response to selection of the asset leasing option 824, embodiments described herein may be configured to facilitate a purchase and/or lease of one or more selected utility assets. In some embodiments, communication may be sent to an owner of the utility asset regarding interest of purchasing and/or leasing the utility asset. In some embodiments, purchase and/or lease may be facilitated via the remote computing device 104 providing one or more options to a user and/or an owner to complete the transaction, including providing payment options, title transfer options, etc. Such embodiments may be configured to determine a final price associated with the transaction and utilize the final price in calculating a future value of a different utility asset, as described in more detail below.

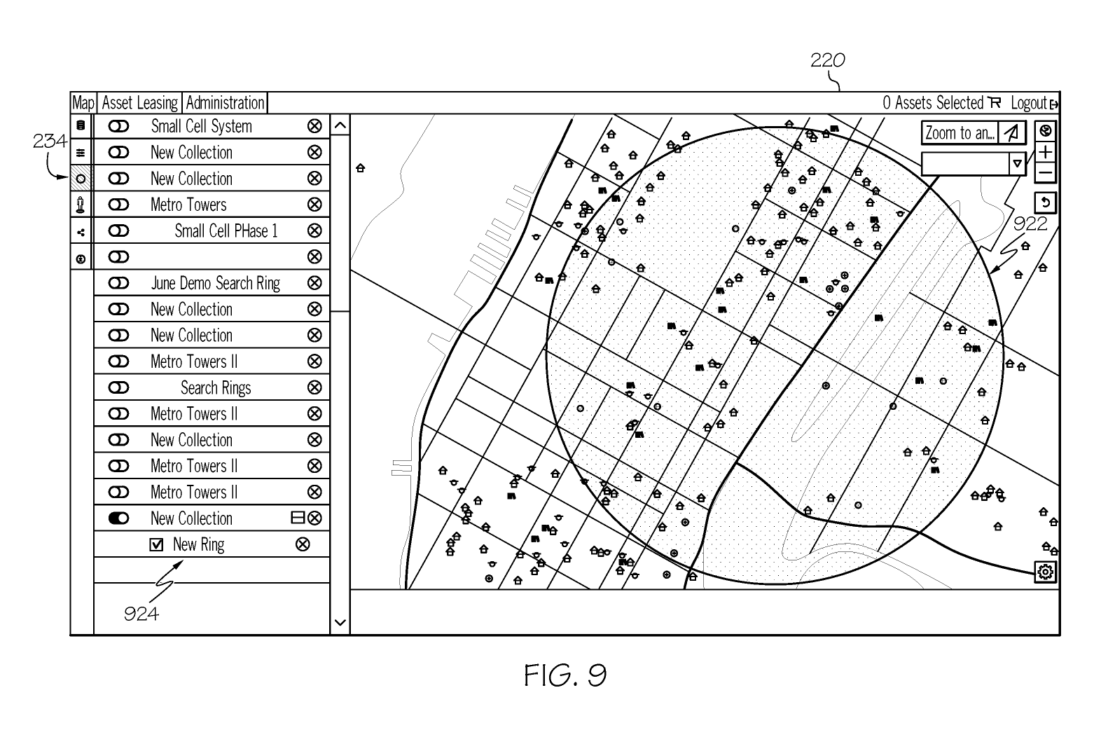

FIG. 9 depicts a user interface 920 that provides a search ring for searching predetermined utility assets within a user-defined radius, according to embodiments described herein. As illustrated, in response to selection of the ring option 236 from FIG. 2 and the new ring option 924, a user defined ring may be created around a predetermined area to capture a plurality of utility assets for further analysis. In some embodiments, the user may explicitly define the ring (such as via a “drag and drop” procedure on the mapping 222). However, some embodiments may provide a user field for the user to enter one or more criteria (such as within a predetermined distance of a utility asset or plurality of utility assets) for creating the ring. As such, some embodiments may provide for rings of varying shapes and sizes, depending on the particular mechanism for creating the ring. In response to receiving a user selection of the new ring option 924, embodiments may provide data related to another asset within the predetermined area, such as in the lower bar area 1022.

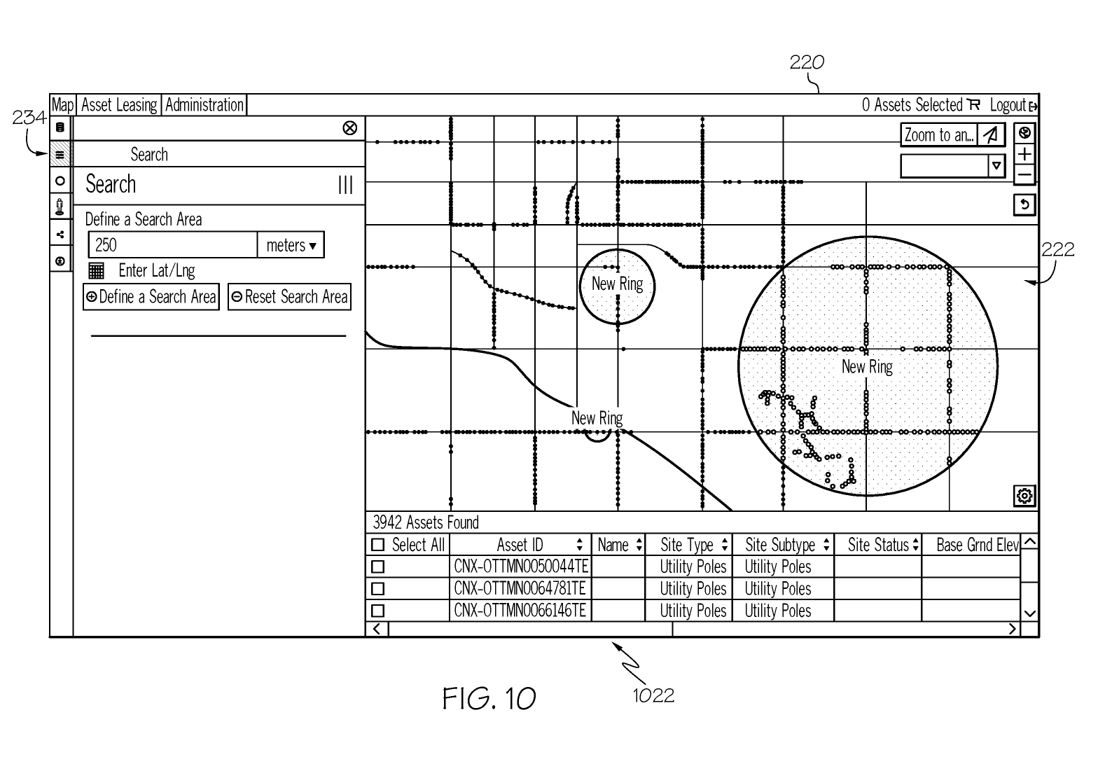

FIG. 10 depicts a user interface 1020 that provides predetermined utility assets within a user-defined search ring, according to embodiments described herein. In response to selection of the search option 234 from FIG. 2, the user may perform a search to define an area on the mapping 222. In response, a lower bar area 1022 may be provided that includes a listing of details regarding utility assets captured within the user defined search. As such, the lower bar area 1022 and/or other portions provided in FIG. 10 may also be provided in response to creation and/or use of a ring discussed in FIG. 9.

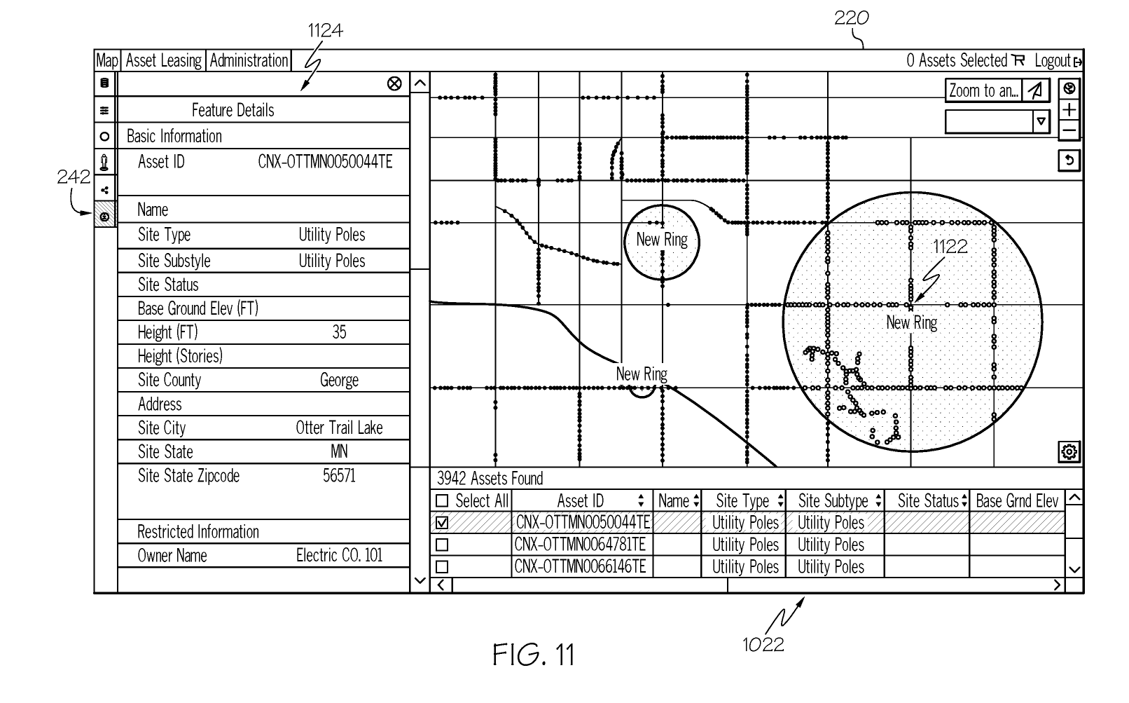

FIG. 11 depicts a user interface 1120 that provides characteristics of a selected utility asset within a search ring 1122, according to embodiments described herein. As illustrated, user-selected utility assets within the search ring 1122 may be provided in the lower bar area 1022. Additionally, a user may select on or ore utility assets in the lower bar area 1022 to provide selected additional details on that utility asset in the sidebar 1124. This information may also be provided via selection of the information option 242.

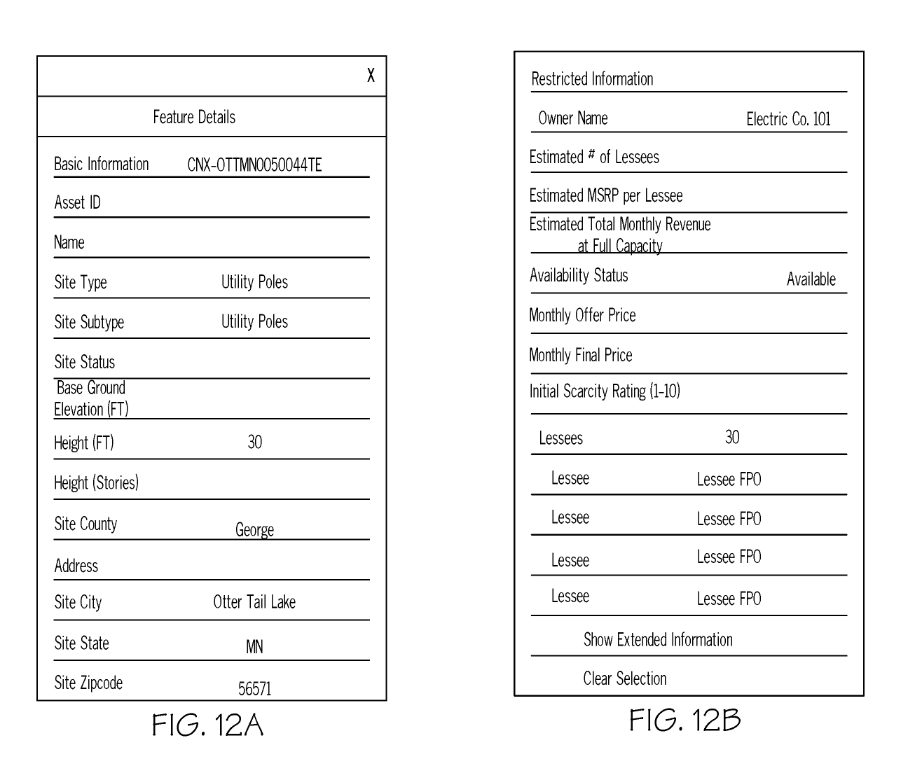

FIGS. 12A, 12B depict additional characteristics of a selected utility asset, according to embodiments described herein. Characteristics may be provided regarding a selected utility asset (such as described with reference to FIG. 11). This information may include a plurality of different types of data, such as basic information, restricted information, and lessee information. As an example, the utility asset selected in FIGS. 12A, 12B includes a utility pole that has a height of 30 feet. A location may also be provided. Restricted information may include an owner name, a number of lessees, a projected lease or sale price, an estimated monthly revenue of the utility asset, an availability status, an offer price, a final price, a scarcity rating, and a listing of current lessees.

It should be understood that embodiments provided herein may be configured to evaluate and/or predict a value of a utility asset (or plurality of utility assets), a predicted lease price, and/or other information regarding a utility asset. Specifically, embodiments provided herein may be configured to assign a predetermined value to various characteristics of a utility asset, depending on asset type. As an example, embodiments described herein may determine the utility assets in a predetermined area, in a user search, and/or stored system wide. Regardless of the mechanism for determining the utility assets, if a utility pole is a utility asset that is being valued, these embodiments may determine values for predefined characteristics for the utility asset. For a utility pole, the embodiments may determine a pole height, a scarcity of similar utility assets in the area, a previous price paid, an availability of space on the utility asset, and/or other characteristics. With each of these characteristics receiving a value, a composite value of the utility asset may be determined. In some embodiments, the composite value may be a purchase value. In some embodiments, the composite value may include a lease value. Additionally, a fair market value, a recommended retail vale, and/or other types of values may be assigned once the characteristic values have been determined.

Additionally, different values may be provided to the same utility asset, depending on the user. As an example, if the user represents an entity that wants to lease utility pole space for a wireless fidelity device, the estimated value may be different than for someone who represents an entity that wishes to install a light on the utility pole because the wireless fidelity device may require a high mount, while the light may be mounted at a plurality of different heights. As such, the lease value for the user that wishes to install the wireless fidelity device may be higher for the same utility pole due to the limited supply of higher mounting spaces. As such, embodiments described herein may be configured to determine a user's requirements in calculating value to purchase or lease another user's utility asset.

It should also be understood that embodiments may be configured to determine and provide recommended expansion of utility assets to certain users. As an example, if the user represents a mobile provider, the user may have data associated with the location of utility assets over a predetermined geographical area. Embodiments described herein may utilize that data (or similar coverage data associated with the entity) to provide in the user interfaces described herein. Additionally, embodiments may determine the utility assets utilized in the area and determine coverage weaknesses. Embodiments may additionally provide information regarding how to expand the coverage area, based on coverage price, and/or other data.

Returning to the previous example, these embodiments may determine the coverage area of each utility asset in the predetermined area. These embodiments may then identify where mobile reception may be weak and determine applicable utility poles, towers, buildings, etc. on which the entity may lease space to expand coverage. In some embodiments, all of the available utility assets may be provided to the user. However, some embodiments may filter or sort the results to provide those utility assets that are most cost effective. Comparisons may additionally be made between and among the potential areas and/or utility assets to provide the user with pertinent information for purchasing or leasing that space. Embodiments described herein may also be configured to facilitate a purchase and/or lease of the space, as described in more detail below.

Some embodiments may, based on morphology of a predetermined area (suburban, urban, rural, dense urban, small cell), search for existing and available open sites within, for example, 120% of the current coverage footprint as well as 120% of the current search ring radius. A qualifying site would be one that also meets predetermined characteristics (such as height, if a utility pole is the utility asset) by a settable percentage (80% to 250%). Desired lease value may be settable by the user. The owner may set the estimated time for installation. The user may also set a desired time for use and/or installation. Sites that meet the highest characteristics would be of highest value to the user, while sites that fall outside of those settable ranges would be of less value. The user may set weighting factors based on the criteria of most importance to them and the score would adjust accordingly. Proximity and criterion based weighted prioritization of assets. The same would be applicable to fiber, but criteria may include cost per strand mile per month, maintenance per strand mile per month, construction costs per sheath mile, underground versus overhead, length of available term versus term desired by the user.

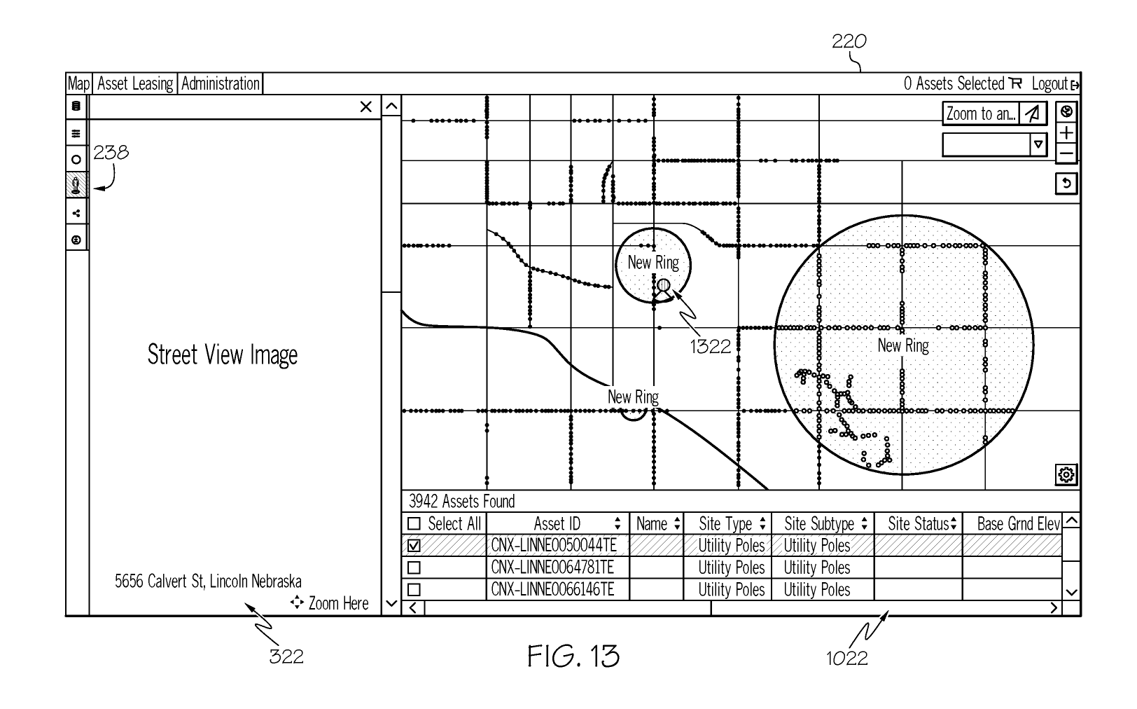

FIG. 13 depicts a user interface 1320 that provides imagery associated with a selected utility asset within a search ring, according to embodiments described herein. In response to selection of a utility asset in the lower bar area 1022, a street view option 1322 may be provided for the utility asset selected within a defined ring may be provided for a virtual inspection of the utility asset.

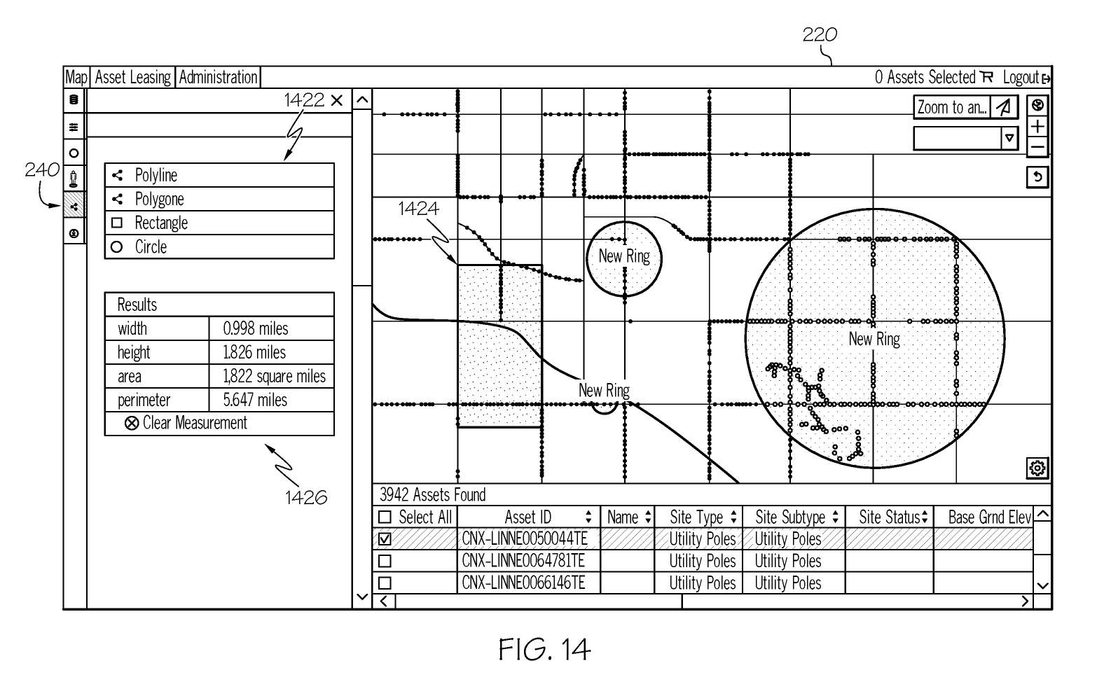

FIG. 14 depicts a user interface 1420 that provides a measurement associated with a user defined area, according to embodiments described herein. In response to selection of the measurement option 240, the menu 1422 may be provided. The menu 1422 provides options for creating a polygon to measure a distance, area, perimeter, etc. In response to creating a polygon 1424 on the mapping 222, a menu 1426 may be provided to indicate data associated with the polygon. Additionally, utility assets that reside within the polygon may be provided in the lower bar area 1022.

It should be understood that utility assets in the lower bar area 1022 and elsewhere may be filtered to provide only those results that the user wishes to view. As an example, utility assets may be filtered based on asset type, owner, price range, and/or other criteria.

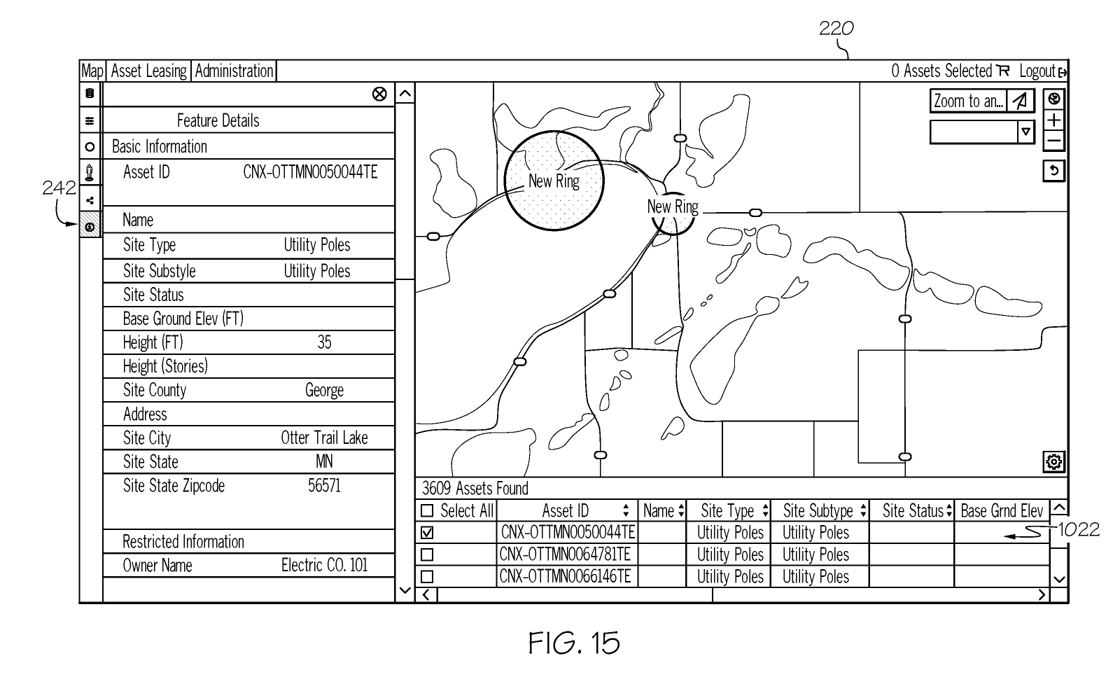

FIG. 15 depicts a user interface 1520 that provides asset leasing information for a selected asset, according to embodiments described herein. As illustrated, information associated with a utility asset or group of utility assets may be provided in response to selection of the information option 242. In some embodiments, the user may be provided with all data associated with a selected asset. However, some embodiments may be configured for the user to select a subset of all information (such as only lease data) for providing at a given time.

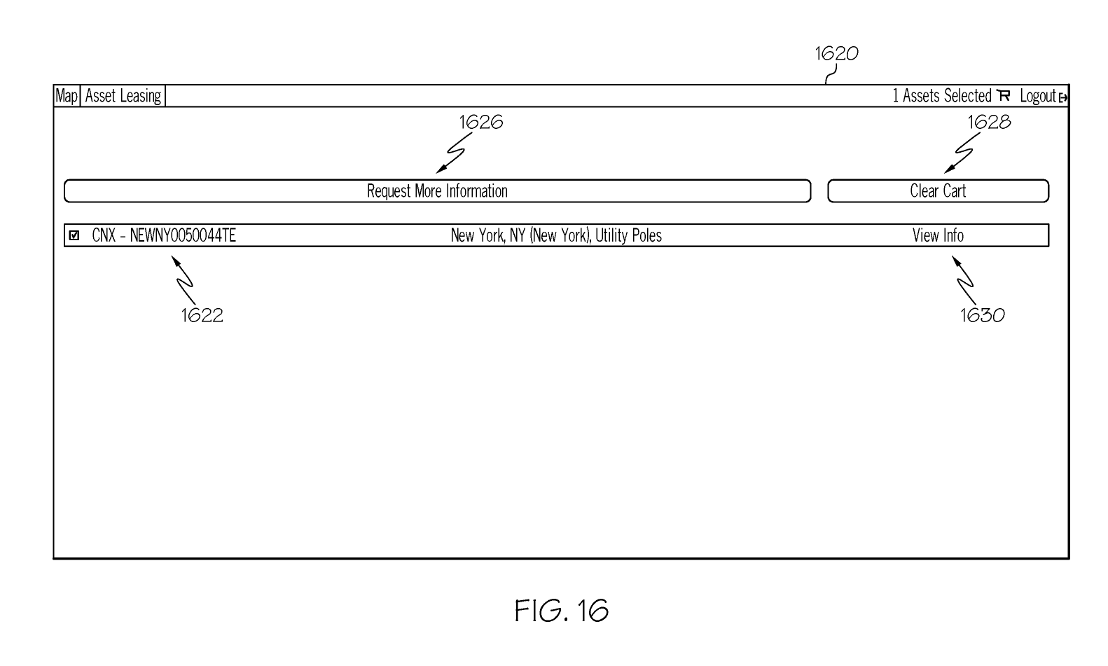

FIG. 16 depicts a user interface 1620 that provides an option for a user to request additional information associated with a selected asset, according to embodiments described herein. As illustrated, a user may select a utility asset from one or more of the user interfaces described above. Once all of the desired assets have been selected, the user may select a request option 1626 to request additional information from the owner of the respective asset.

Once the user has requested information, the owner of the utility asset (and/or other appropriate party) will receive a notification (such as an email, application notification, text message, etc.) of the request for information. The owner may then respond to the information request with a typed response and/or may submit information for inclusion in one or more of the user interfaces described herein. Once the owner has responded, an option 1630 may be provided for the user to view the additional information regarding the selected asset. Once selected, the additional data for the selected asset 1622 may be provided. In response to selection of the clear option 1628, the user interface 1620 may be cleared.

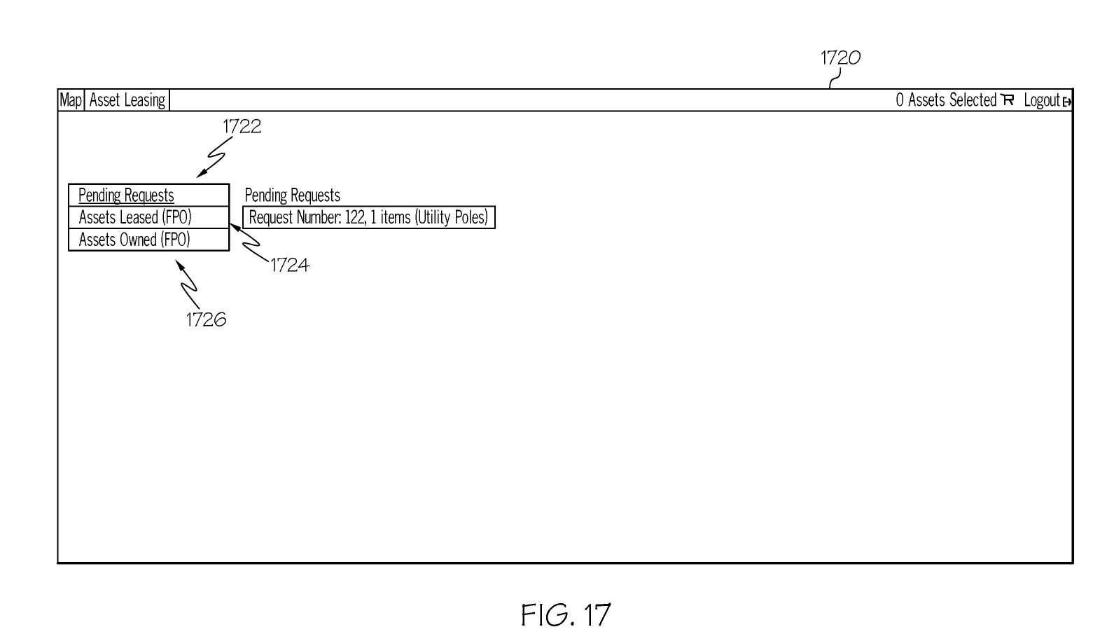

FIG. 17 depicts a user interface 1720 for providing a user with a list of pending requests, according to embodiments described herein. Specifically, in response to selection of an option 1722, embodiments may provide a list of utility assets for which the user has requested information. In response to selection of an assets leased option 1724, a list of currently leased assets may be provided. In response to selection of a utility asset owned option 1726, a list of currently owned assets may be provided.

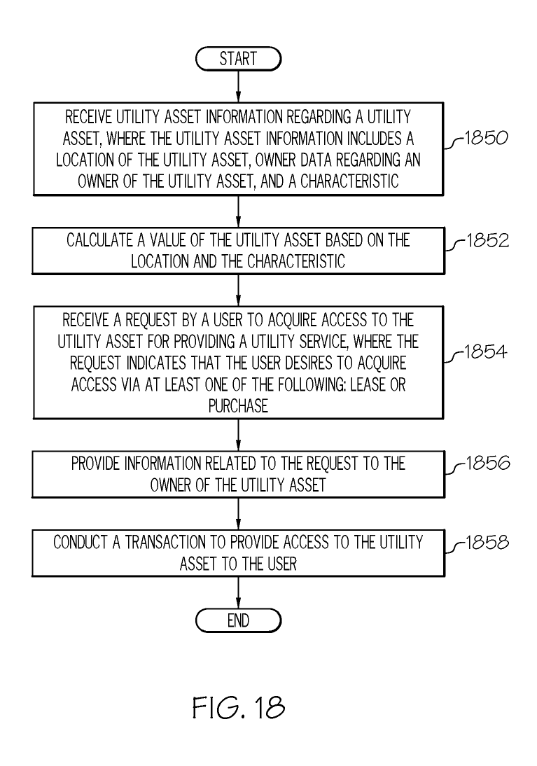

FIG. 18 depicts a flowchart for providing complied utility asset information, according to embodiments described herein. As illustrated in block 1850, utility asset information regarding a utility asset may be received, where the utility asset information includes location of the utility asset, owner data regarding an owner of the utility asset, and a characteristic of the utility asset. In block 1852, a value of the utility asset may be calculated based on the location and the characteristic. As discussed above, the calculation may include weighting a plurality of characteristics of the utility asset based on a predetermined algorithm, where the predetermined algorithm is determined based on a characterization of the utility asset into an asset type. In block 1854, a request from a user may be received to acquire access to the utility asset for providing a utility service, where the request indicates that the user desires to acquire access to the utility asset via a lease and/or a purchase. As an example, a user may wish to acquire access to a utility pole to add coverage area to a mobile data service. In block 1856, information related to the request may be provided to the owner of the utility. In block 1858, a transaction may be conducted to provide the user with access to the utility asset.

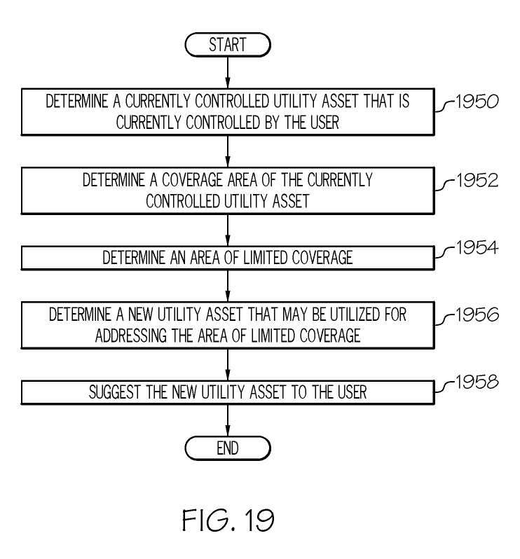

FIG. 19 depicts a flowchart for assessing coverage limitations for a utility asset owner, according to embodiments described herein. In block 1950, a currently controlled utility asset that is currently controlled by the user may be determined. In block 1952, a coverage area of the currently controlled utility asset may be determined. In block 1954, an area of limited coverage may be determined. In block 1956, a new utility asset may be determined that may be utilized for addressing the area of limited coverage. As an example, if the user owns and/or controls wireless fidelity devices, embodiments descried herein may determine where wireless is not available. Once the area of limited coverage is determined, embodiments may determine assets in the area that could be utilized by the user to overcome the limitation (such as via a determination of a building on which a new wireless fidelity device may be installed to improve coverage). In block 1958, the new utility asset may be suggested to the user.

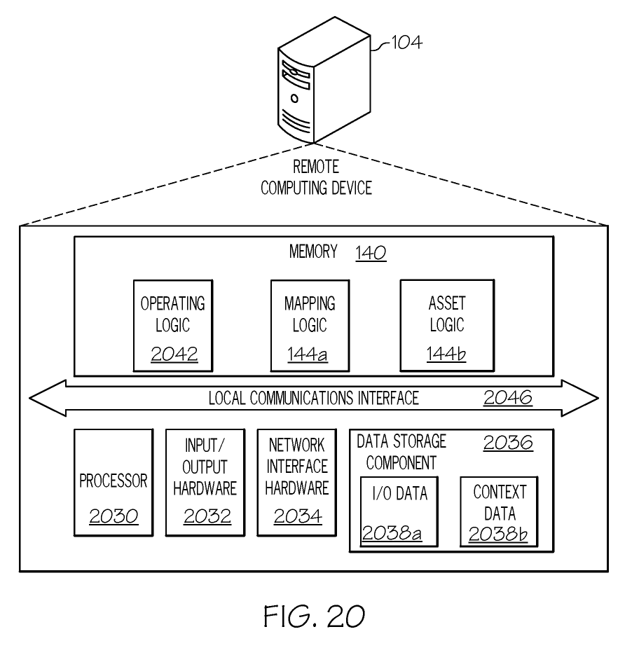

FIG. 20 depicts a remote computing device 104 for providing compiled utility asset information, according to embodiments described herein. As illustrated, the remote computing device 104 includes a processor 2030, input/output hardware 2032, the network interface hardware 2034, a data storage component 2036 (which stores mapping data 2038a, asset data 2038b, and/or other data), and the memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the remote computing device 104 and/or external to the remote computing device 104.

The memory component 140 may store operating logic 2042, the mapping logic 144a, and the asset logic 144b. The mapping logic 144a and the asset logic 144b may each include a plurality of different pieces of logic, each of which may be embodied as a computer program, firmware, and/or hardware, as an example. A local interface 2046 is also included in FIG. 20 and may be implemented as a bus or other communication interface to facilitate communication among the components of the remote computing device 104.

The processor 2030 may include any processing component operable to receive and execute instructions (such as from a data storage component 2036 and/or the memory component 140). The input/output hardware 2032 may include and/or be configured to interface with microphones, speakers, a display, and/or other hardware.

The network interface hardware 2034 may include and/or be configured for communicating with any wired or wireless networking hardware, including an antenna, a modem, LAN port, wireless fidelity (Wi-Fi) card, WiMax card, Bluetooth chip, USB card, mobile communications hardware, and/or other hardware for communicating with other networks and/or devices. From this connection, communication may be facilitated between the remote computing device 104 and other computing devices, such as the user computing device 102.

The operating logic 2042 may include an operating system and/or other software for managing components of the remote computing device 104. As also discussed above, the mapping logic 144a may reside in the memory component 140 and may be configured to cause the processor 2030 to apply known locations for utility assets to an interactive map. Similarly, the asset logic 144b may be utilized to receive and/or otherwise determined locations and other data related to utility assets, as described herein and depicted.

It should be understood that while the components in FIG. 20 are illustrated as residing within the remote computing device 104, this is merely an example. In some embodiments, one or more of the components may reside external to the remote computing device 104. It should also be understood that, while the remote computing device 104 is illustrated as a single device, this is also merely an example. In some embodiments, the mapping logic 144a and the asset logic 144b may reside on different computing devices. As an example, one or more of the functionality and/or components described herein may be provided by a remote computing device 104 and/or user computing device 102, which may be coupled to the remote computing device 104 via the network 100.

Additionally, while the remote computing device 104 is illustrated with the mapping logic 144a and the asset logic 144b as separate logical components, this is also an example. In some embodiments, a single piece of logic (and/or or several linked modules) may cause the remote computing device 104 to provide the described functionality.

Embodiments described herein provide systems and methods for acquiring data related to a utility asset or a plurality of utility assets. These embodiments provide this data via one or more user interfaces that allows the user to view existing assets for a predetermined location, as well as inquire as to details of those existing utility assets. Depending on the particular embodiment, the utility assets may include traditional utility and/or telecom assets and may include utility poles, buildings, water towers, cell towers, fiber networks, cable networks, wireless networks, FCC towers, and the like as depicted and described herein. Regardless, a provider may additionally view areas that may need updating and/or otherwise has a deficiency in the asset coverage. Based on that determination, embodiments may provide a connection between municipalities and providers for correcting those deficiencies and/or facilitating an exchange to provide additional utility assets or other services.

As illustrated above, various embodiments for compiling utility asset information are disclosed. Accordingly, these embodiments allow providers to view areas of a locale that are in need of updated assets and/or other services. This enables the providers and others the ability to view utility assets and areas and make decisions on whether to utilize city or government-owned utility assets to expand. This also allows the providers and others to transact with the municipalities in an online exchange for physical service.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein includes systems, methods, and non-transitory computer-readable mediums for compiling utility asset information. It should also be understood that these embodiments are merely exemplary and are not intended to limit the scope of this disclosure.

What is claimed is:

1. A method for compiling utility asset information comprising:
receiving, by a computing device, utility asset information regarding a utility asset, wherein the utility asset information includes a location of the utility asset, owner data regarding an owner of the utility asset, and a characteristic;
calculating, by the computing device, a value of the utility asset based on the location and the characteristic;
receiving, by the computing device, a request by a user to acquire access to the utility asset for providing a utility service, wherein the request indicates that the user desires to acquire access via at least one of the following: lease or purchase;
providing, by the computing device, information related to the request to the owner of the utility asset; and
conducting, by the computing device, a transaction to provide access to the utility asset to the user.

2. The method of claim 1, further comprising:
determining a currently controlled utility asset that is currently controlled by the user;
determining a coverage area of the currently controlled utility asset;
determining an area of limited coverage;
determining a new utility asset that may be utilized for addressing the area of limited coverage; and
suggesting the new utility asset to the user.

3. The method of claim 1, further comprising:
determining a final price associated with the transaction; and
utilizing the final price in calculating a future value of a different utility asset.

4. The method of claim 1, further comprising:
providing a user interface that provides a mapping of the utility asset;
providing a ring option for the user to view data within a predetermined area around the utility asset; and
in response to receiving a user selection of the ring option, providing data related to another asset within the predetermined area.

5. The method of claim 1, further comprising:
providing a street view of the utility asset to the user;
providing an option to adjust the characteristic of the utility asset based on an image represented in the street view;
receiving a user selection of the option and a new value for the characteristic;
associating the new value with the utility asset; and
recalculating the value of the utility asset based on the new value.

6. The method of claim 1, further comprising providing an option to the owner of the utility asset to offer at least a portion of the utility asset for at least one of the following: sale or lease.

7. The method of claim 1, wherein calculating the value of the utility asset includes weighting a plurality of characteristics of the utility asset based on a predetermined algorithm, wherein the predetermined algorithm is determined based on a characterization of the utility asset into an asset type.

8. A system for compiling utility asset information comprising:
a computing device that includes a processor and memory, the memory storing logic that, when executed by the processor, causes the system to perform at least the following:
receive utility asset information regarding a plurality of utility assets, wherein the utility asset information includes a location of at least a portion of the plurality of utility assets, owner data regarding an owner of at least a portion of the plurality of utility assets, and a characteristic of at least a portion of the plurality of utility assets;
calculate a value of at least one of the plurality of utility assets based on the location and the characteristic;
receive a request by a user to acquire access to the utility asset for providing a utility service;
provide information related to the request to the owner of the utility asset; and
conduct a transaction to provide access to the utility asset to the user.

9. The system of claim 8, wherein the logic further causes the system to perform at least the following:
determine a currently controlled utility asset that is currently controlled by the user;
determine a coverage area of the currently controlled utility asset;
determine an area of limited coverage;
determine a new utility asset that may be utilized for addressing the area of limited coverage; and
suggest the new utility asset to the user.

10. The system of claim 8, wherein the logic further causes the system to perform at least the following:
determine a final price associated with the transaction; and
utilize the final price in calculating a future value of a different utility asset.

11. The system of claim 8, wherein the logic further causes the system to perform at least the following:
provide a user interface that provides a mapping of the utility asset;
provide a ring option for the user to view data within a predetermined area around the utility asset; and
in response to receiving a user selection of the ring option, provide data related to another asset within the predetermined area.

12. The system of claim 8, wherein the logic further causes the system to perform at least the following:
provide a street view of the utility asset to the user;
provide an option to adjust the characteristic of the utility asset based on an image represented in the street view;
receive a user selection of the option and a new value for the characteristic;
associate the new value with the utility asset; and
recalculate the value of the utility asset based on the new value.

13. The system of claim 8, wherein the logic further causes the system to provide an option to the owner of the utility asset to offer at least a portion of the utility asset for at least one of the following: sale or lease.

14. The system of claim 8, wherein calculating the value of the utility asset includes weighting a plurality of characteristics of the utility asset based on a predetermined algorithm, wherein the predetermined algorithm is determined based on a characterization of the utility asset into an asset type.

15. A non-transitory computer-readable medium for compiling utility asset information that includes logic that, when executed by a computing device, causes the computing device to perform at least the following:
receive utility asset information regarding a plurality of utility assets, wherein the utility asset information includes a location of at least a portion of the plurality of utility assets, owner data regarding an owner of at least a portion of the plurality of utility assets, and a characteristic of at least a portion of the plurality of utility assets;
calculate a value of at least one of the plurality of utility assets based on the location and the characteristic, wherein calculating the value of the utility asset includes weighting a plurality of characteristics of the utility asset based on a predetermined algorithm, wherein the predetermined algorithm is determined based on a characterization of the utility asset into an asset type;
receive a request by a user to acquire access to the utility asset for providing a utility service;
provide information related to the request to the owner of the utility asset; and
conduct a transaction to provide access to the utility asset to the user.

16. The non-transitory computer-readable medium of claim 15, wherein the logic further causes the computing device to perform at least the following:
determine a currently controlled utility asset that is currently controlled by the user;
determine a coverage area of the currently controlled utility asset;
determine an area of limited coverage;
determine a new utility asset that may be utilized for addressing the area of limited coverage; and
suggest the new utility asset to the user.

17. The non-transitory computer-readable medium of claim 15, wherein the logic further causes the computing device to perform at least the following:
determine a final price associated with the transaction; and
utilize the final price in calculating a future value of a different utility asset.

18. The non-transitory computer-readable medium of claim 15, wherein the logic further causes the computing device to perform at least the following:
provide a user interface that provides a mapping of the utility asset;
provide a ring option for the user to view data within a predetermined area around the utility asset; and
in response to receiving a user selection of the ring option, provide data related to another asset within the predetermined area.

19. The non-transitory computer-readable medium of claim 15, wherein the logic further causes the computing device to perform at least the following:
provide a street view of the utility asset to the user;
provide an option to adjust the characteristic of the utility asset based on an image represented in the street view;
receive a user selection of the option and a new value for the characteristic;
associate the new value with the utility asset; and
recalculate the value of the utility asset based on the new value.

20. The non-transitory computer-readable medium of claim 15, wherein the logic further causes the computing device to provide an option to the owner of the utility asset to offer at least a portion of the utility asset for at least one of the following: sale or lease.
